(19) United States
(12) Patent Application Publication
(10) Pub. No.: US 2010/0257593 A1
(43) Pub. Date: Oct. 7, 2010

(54) Social Networking Platform with Synchronized Communication Device

(76) Inventors: Roy Avelo, Chicago, IL (US); Edward Suda, Chicago, IL (US); Alessandro Segre, Evanston, IL (US)

Correspondence Address: MCCRACKEN & FRANK LLP, 311 S. WACKER DRIVE, SUITE 2500, CHICAGO, IL, 60606, US

(21) Appl. No.: 12/756,060

(22) Filed: Apr. 7, 2010

Related U.S. Application Data
(60) Provisional application No. 61/167,342, filed on Apr. 7, 2009.

(51) Int. Cl. G06F 21/00; G06F 15/16

(52) U.S. Cl. 726/4; 709/206; 726/3

(57) ABSTRACT

A device that connects to an online social networking website. Transfer of data from the device to the website and from the website to the device serves as a user authentication system. Wireless exchange of data from a device operated by a first user to a device operated by a second user enables the first user to grant access to the second user to information private to the first user on the website. The first user may also use the device thereof to send messages to the device of the second user. Also, the first user may use a device thereof to enter a motion-password to gain access to a website or other software.

### CROSS REFERENCE TO RELATED APPLICATIONS

The present application claims benefit of U.S. Provisional Application No. 61/167,342 filed Apr. 7, 2009, the entire contents of which are incorporated herein by reference.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to providing authorized access to data associated with web sites and in particular use of a device to transfer authorization information from one user to another. Such devices may also be used to communicate among users.

2. Description of the Background of the Invention

Technologies have been developed that allow groups of individuals to communicate with one another and form computer based social networks. Typically, such technologies allow a participant to use a web site to identify and communicate with other users of the web site who may share interests or have a common background therewith and foster communications therebetween.

Some social networking web sites such as Facebook (www.facebook.com) or MySpace (www.myspace.com) allow a user, who has registered with the web site, to search for another individual whom to invite to join the user's social network (or “friend” the user) or to request that the user be added to the individual's network. Typically, the searching facilities provided by a social networking web site allow a user to search for another member who has registered with the web site based on the name, interests, and/or background (such as schools attended, employers, cities inhabited, etc.). Such open ended searching facilities allow the user to identify other members of the social networking web site who they already know or members who they would like to meet in an electronic community.

The capabilities of the types of social networks described above may be appropriate for certain types of users, but may expose other users to inappropriate or unwanted behavior or contact.

Parents in particular may be concerned about the potential risks of allowing their children to use social networking websites, especially those websites that permit searching and contacting members without prior authorization. Similarly, a person who wishes to use a social networking website to communicate only with other people he or she knows may not want to be bothered by requests from a stranger or long lost acquaintance, for example, to join their network. Some people may avoid joining social networking sites simply because of the risks and overhead required to limit their communications to those people they already know.

### SUMMARY OF THE INVENTION

According to one aspect of the invention a method for allowing first and second participants access to a data stored on a server, wherein the data is associated with a user, includes the steps of associating first and second authentication devices with the first and second participants, respectively. The method also includes the steps of associating an authentication device with the user, substantially simultaneously transmitting authentication information from the authentication device associated with the user to the first and second devices, and transmitting the authentication information from the first device to an authentication server, whereby the authentication server provides the first participant and the second participant access to the data.

In another aspect of the invention, a device associated with a user for allowing first and second participants access to data stored on a server and associated with the user includes a memory for storing authentication information, a wireless transceiver that substantially simultaneously receives first and second authentication information from devices operated by the first and second participants, respectively, and stores such authentication information into the memory. The device further includes an interface that transfers the authentication information stored in the memory to a server, whereby the server provides the first and second participants access to the data.

Other aspects and advantages of the present invention will become apparent upon consideration of the following detailed description.

### BRIEF DESCRIPTION OF THE DRAWINGS

FIG. 1 comprises an illustration of an embodiment of a device according to the present disclosure;

FIG. 2 comprises a block diagram of the components of an embodiment of the device of FIG. 1;

FIG. 3 comprises a block diagram of an embodiments of a system with which the device of FIG. 1 may be used;

FIG. 4 comprises a flowchart of programming executed by the web host of the system of FIG. 3;

FIG. 5 comprises a flowchart of programming executed by a processor of the device of FIG. 1;

FIG. 6 comprises an illustration of how a plurality of devices according to one embodiment of the present disclosure may be operated;

FIG. 7 comprises another illustration of how a plurality of devices according to one embodiment of the present disclosure may be operated;

FIG. 8 comprises a flowchart of programming executed by a processor of one the plurality of devices of FIG. 6 and FIG. 7;

FIG. 9A comprises another flowchart of programming executed by a processor of one of the plurality of devices of FIG. 6 and FIG. 7;

FIG. 9B comprises still another flowchart of programming executed by a processor of one of the plurality of devices of FIG. 6 and FIG. 7;

FIG. 10 comprises an illustration of a web page that may be used by a user of a device illustrated in FIG. 1;

FIG. 11 comprises an illustration of another web page that may be used by a user of a device of FIG. 1.

FIG. 12 comprises a block diagram of the components of another embodiment of the device of FIG. 1;

FIG. 13 comprises a flowchart of programming executed by the processor of the device of FIG. 1; and

FIG. 14 comprises an illustration of a user interface that may be used by a user of the device of FIG. 1.

### DETAILED DESCRIPTION OF THE PREFERRED EMBODIMENTS

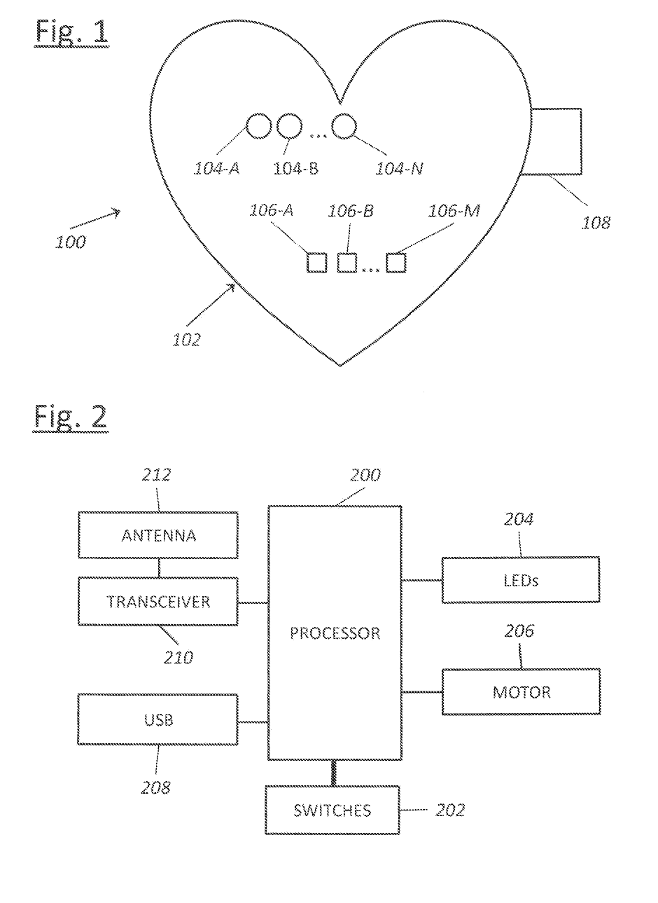

FIG. 1 shows a device 100 that may be used by a bearer thereof to allow another individual to communicate therewith on a social network web site. In particular, the device 100 comprises a shell 102 to protect and/or conceal the electronics that operate the device 100. The device 100 further comprises one or more switches 104, one or more light-emitting diodes (LEDs) 106, and a connector 108 that may be used to interface the device 100 to a computer (not shown).

In one embodiment, the shell 102 is made from a hard, opaque plastic with orifices through which the switches 104 and the LEDs 106 protrude. In other embodiments the shell 102 is made from a hard, translucent or transparent plastic with orifices from which the switches 104 protrude. In such an embodiment, the LEDs 106 may protrude or may be disposed beneath the shell 102 in such manner that the shell 102 protects the LEDs 106 yet allows light emitted by the LEDs 106 to be transmitted therethrough. In still other embodiments, the shell 102 may be made from a pliable material and the switches 104 positioned so that such switches are protected by the shell but the switched 104 may be actuated by pressing on the shell. In addition to plastics, a number of different types of materials may be used for the shell including metals, woods, polycarbonates, fabrics and cloth, and the like. In some embodiments, the shell may be embedded or inserted into a plush toy.

In some embodiments of the device 100, the switches 104 may be electro-mechanical switches, capacitance switches, resistance switches, a touch-screen component, or a combination thereof. The switches 104 may also be hall-effect switches that may be actuated by proximity to a magnetic field or spring-based that may be actuated by shaking the device 100.

FIG. 2 illustrates a block diagram of an embodiment of circuit that may be used to operate the device 100. The circuit comprises a processor 200. The processor 200 is coupled to switches 202, one or more LEDs 204, a motor 206, a USB interface 208, and a transceiver 210. In some embodiments the processor 200 may be a microcontroller such as the PIC18LF2550 manufactured by the MicroChip Technology Inc., of Chandler, Ariz., that provides some functions of the USB interface 208 therewith. In other embodiments, the processor 200 may be a microcontroller such as the CC1111F8, CC1111F16, or CC1111F32 manufactured by Texas Instruments, Inc., of Dallas, Tex., that includes the USB interface 208 and the transceiver 210 therewith. It should be apparent that other types of processors may be used that incorporate the functionality of the USB interface 208 and/or the transceiver 210. If a processor 200 is used that does not include such functionality, additional electronic components may be used to provide such functionality. In some embodiments, the processor 200 includes memory therewith. In other embodiments, the processor 200 may be coupled to an external memory chip(s) including RAM, FLASH, EEPROM, and the like and controller therefore. It should be apparent that the circuit may also have additional components including batteries, battery chargers, LED drivers and/and motor drivers to power and/or control the LEDs 204 and/or the motor 206, respectively, power regulators, and timers. Such components may be discrete components or incorporated into the processor 200.

In some embodiments, only one monocolor LED 204 may be used. In other embodiments, a plurality of LEDs 204 is used. In still further embodiments, red, green, and blue LEDs 204 are used and controlled to produce a gamut of colors.

In some embodiments, the transceiver 210 is configured to transmit and receive data using predetermined radio frequencies. In other embodiments, the processor 200 configures the radio frequency band the transceiver 210 should use to transmit and receive signals using a radio frequency when the device is powered. The processor 200 may select such radio frequency band from data stored in the memory thereof. The transceiver 210 may be configured to use either licensed or unlicensed bands of the radio spectrum. For example, the transceiver may be configured to operate between approximately 2.4 GHz and 2.5 GHz, between approximately 902 MHz and 928 Mhz, between approximately 433.05 and 434.79 MHz, or between approximately 865 and 868 Mhz. It should be apparent that other frequency bands may be used. The transceiver may also operate using frequencies used for networks such as a paging network.

In some embodiments, the processor 200 writes data that is to be transmitted into a transmit-buffer memory of the device associated with the transceiver 210, and the transceiver 210 retrieves data in a first-in/first-out fashion from the transmit-buffer, generates a signal encoding such data, and transmits the generated signal using an antenna 212. Some embodiments also include a receive-buffer memory associated with the transceiver 210 into which the transceiver 210 writes data decoded from a received signals via antenna 212 and the processor 200 may retrieve data from the receive-buffer in a first-in/first-out fashion. In this manner, the processor 200 and transceiver 210 may operate in an asynchronous fashion. Similar buffering schemes may be used to coordinate the operations of the processor 200 and the USB interface 208 and the processor 200 and the driver that controls the LEDs 204.

It should be apparent that other types of sensory output devices may be used in addition to or instead of the LEDs 204 and the motor. In some embodiments, the output device may include one or more LCD, OLED, e-Ink, or similar visual display component(s) in addition to or instead of the LEDs 204. Such component(s) may be operated to display a visual indication in a manner similar to the LEDs 204. Other types of sensory output devices include a multi-pixel display that can show images, tactile output devices including devices that can generate heat or control temperature, piezo-electric vibration, fragrance dispensing devices, and the like.

Some embodiments of the device 100 include a loudspeaker or other component that can generate an audible indication. Such component may be operated by the processor 200 to generate an audible signal.

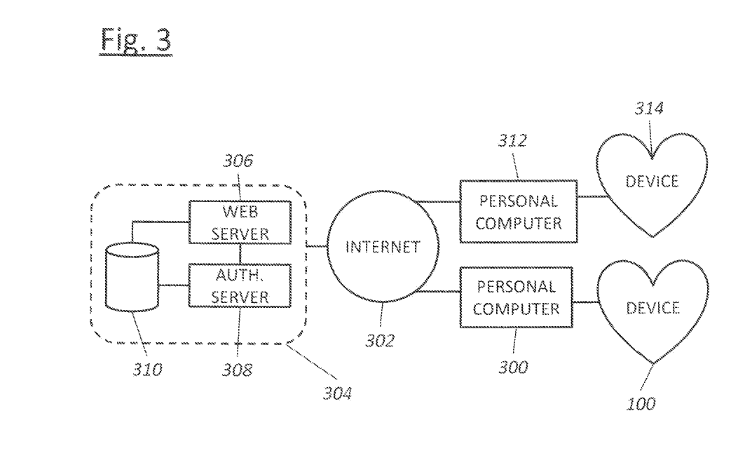

FIG. 3 illustrates an embodiment of how a device 100 may be used with a social networking web site software operated using a web server 304. The USB connector of the device 100 is plugged into the USB port of a personal computer 300. The personal computer 300 connects over a network 302, such as the Internet, to a web host 304. The web host 304 comprises a web server 306, an authentication server 308, and a database 310. It should be apparent, the personal computer 300 may be a desktop computer, a laptop or handheld computer, a cellular device such as a smart phone, a personal digital assistance, or another device that enables a user to engage in an online environment. It should also be apparent, that other forms of communication between the device 100 and the personal computer 300 may be used including Firewire, Ethernet, Wi-Fi, cellular communications, Bluetooth, and the like.

To initialize the device 100, the user plugs the USB connector of the device 100 into the USB port of personal computer 300 and directs a web browser operating on the personal computer 300 to web site software provided by the web server 306. The web site software allows the user to download communications software that facilitates communications between the web site software and/or the personal computer 300 and the device 100. Alternately, such communications software may be provided on a separate storage device such as a flash drive, a CD-ROM, a DVD, or in the memory of the device 100. If the communications software is provided in the memory of the device 100, such software may be available when the USB connector device 100 is plugged into the USB port of the personal computer 300. In some embodiments the communications software and/or the personal computer 300 is configured to launch when the operating system is loaded or shortly thereafter, for example, each time the personal computer 300 is booted. In other embodiments the communications software and/or the operating system of the personal computer 300 is configured to start each time the device 100 is plugged into the personal computer 300. In still other embodiments, the communications software may be configured to launch when a web browser is launched on the personal computer 300 or when requested by the web site software provided by the web server 306.

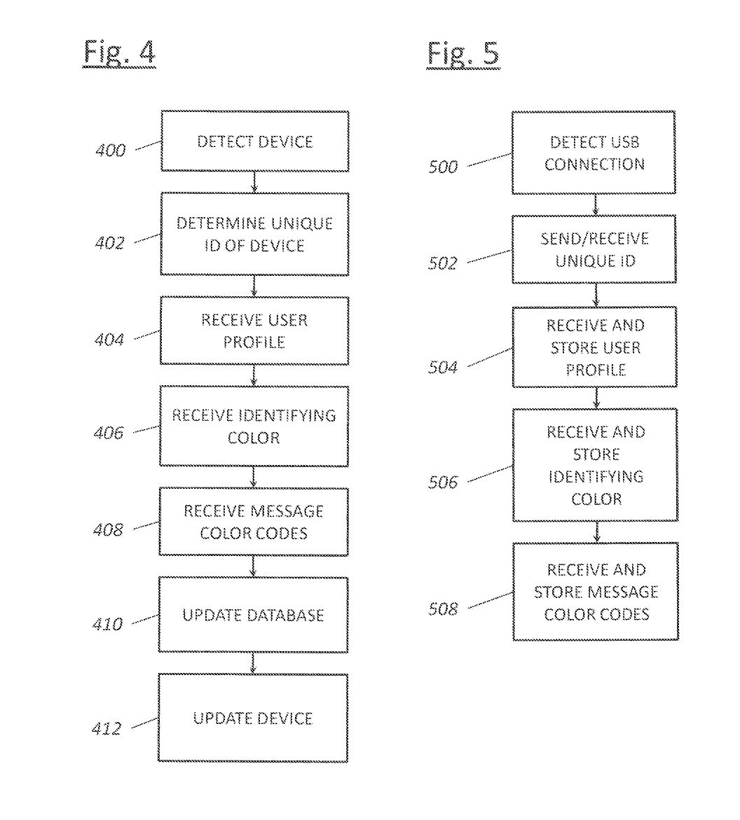

FIG. 4 shows a flowchart of the steps undertaken by the web site software to initialize a new device 100. A block 400 communicates with the communications software to insure that a device is connected to the personal computer 300 on which the communications software is operating. In some embodiments, the communications software comprises listening software that monitors the connection between the personal computer 300 and the device 100. The listening software may be a plug-in or a driver specific to the device or may be, for example, USB driver software.

A block 402 determines a unique ID for the device 100. In one embodiment, the block 402 generates a request to the authentication server to generate a new unique ID and thereafter directs the communications software to store such unique ID in the memory of the device 100. In some embodiments unique ID may be a 32-bit value, although it should be apparent that values of any length may be used to represent the unique ID.

In other embodiments, the block 402 directs the communications software to retrieve from the device 100 a unique ID previously stored in the memory of the device 100 and provide such unique ID to the web site software. In such embodiments, the unique ID of the device 100 may be stored during a manufacturing step thereof or when the device 100 is packaged or distributed.

The communications software may be a browser plug-in or a standalone program that operates on the personal computer 300. In some embodiments, the communications software may poll the web server 306 and/or the authentication server 308 periodically to determine if any data needs to be retrieved from the device and if so retrieves such data and transmits the retrieved the data to the web server 306 and/or the authentication server 308. Similarly, the communications software may poll the web server 306 and or the authentication server 308 periodically to determine if any data needs to be downloaded to the device, and if so, retrieves such data from the web server and/or authentication server 308 and downloads such data to the device 100. In some embodiments the communications software uses a web services protocol such as SOAP or RPC to communicate with the web server 306 and/or the authentication server 308.

After the unique ID is determined by the block 402, a block 404 prompts the user to create a profile therefor. The profile may include such information as a name associated with the device 100, the name of the user and/or personal information about the user including school, favorites (foods, books, music, etc.), and the like. A block 406 prompts the user to select an identifying color and the block 408 prompts the user one or more message color codes, wherein each color code is associated with a message selected or defined by the user. The prompts of blocks 404-408 may be provided on a plurality of web pages generated by the web site software or such prompts may be fields that the user completes on one web page generated by the web site software. In the later case, the blocks 404-408 are undertaken as a single step of obtaining profile and configuration information from the user. The use of the identifying color and message color codes is described further hereinbelow. In some embodiments, the user may not be required to select any identifying color and/or message color codes. In other embodiments, the web site may be preconfigured with certain message color codes and the user is prompted select any additional message color codes desired thereby.

In some embodiments, the communications software operating on the personal computer 300 prompts the user to provide the information gathered by the block 404-408 and transmits such information to web site software.

A block 410 creates an entry in the database 310 and records the unique ID and the profile therein. A block 412 directs the communications software to store certain information of the profile in the memory of the device 100. Such information of the profile may include the unique ID (if necessary), unique IDs of friends of the user, the identifying color, and/or message color codes.

FIG. 5 shows steps undertaken by the processor 200 when the device 100 is connected to the personal computer 300 using a USB interface. A block 500 detects the USB connection and waits for communications to be initiated from the personal computer 300. In some embodiments, a control process operating on the processor 200 polls the USB interface for a connection and initiates the block 500 when such a connection is detected. In other embodiments, the USB interface is configured to generate an interrupt when a USB connection is made, wherein the interrupt directs the processor 200 to undertake the block 500.

Following the block 500, in embodiments in which the web site software provides the unique ID for the device 100, a block 502 waits for a unique ID to be provided thereto from the communications software. Upon receiving such unique ID, the block 502 writes the unique ID into a predefined memory location in the device 100 and proceeds to a block 504. In other embodiments, in which the unique ID is preconfigured into the device 100, the block 502 waits for a message from the communications software requesting such unique ID and in response retrieves the unique ID from a predefined memory location in the device 100, transmits such unique ID to the communications software, and proceeds to the block 504.

The block 504 receives a profile from the communications software and stores such profile into the memory of the device 100 reserved for such information. A block 506 receives from the communications software the identifying color associated with the user and stores such color into the memory of the device 100 at a memory location designated therefor and a block 508 receives from the communications software message color codes selected by the user and stores such codes at a memory location therefor.

Referring once again to FIG. 3, another user may initialize another device 314 by plugging the USB connector of such device into a personal computer 312. The initialization and profile downloading process described hereinabove may be used in an identical fashion to initialize the device 314.

In one embodiment, the user of the device 100 may direct the communications software to modify the unique ID associated with the device 100. In such embodiments, the communications software obtains a new unique ID from the authorization server 308 and sends the new unique ID to the processor 200 of the device 100 using the USB interface 208. The communications software also sends to such processor 200 an instruction than the unique ID stored in the memory of the device 100 be overwritten with the new unique ID. The authorization server 308 also modifies the entry in the database 310 associated with the user to include the new unique ID. The user may also be provided an opportunity to modify or delete other information associated with such user or with the device 100 used thereby including color associated with the user, message color codes, the name of the user, interest information, and the like. A user may wish to do this, for example, before the device 100 is transferred to another user.

In some embodiments, the user may delete a unique ID and/or the profile associated with the device operated thereby from the authentication server 308. The next time the device associated with such user is plugged into a personal computer, the authorization server 308 directs the communications software on the personal computer to clear the unique ID from the memory of the device. The user may wish to do this, for example, if the device operated thereby is lost or stolen.

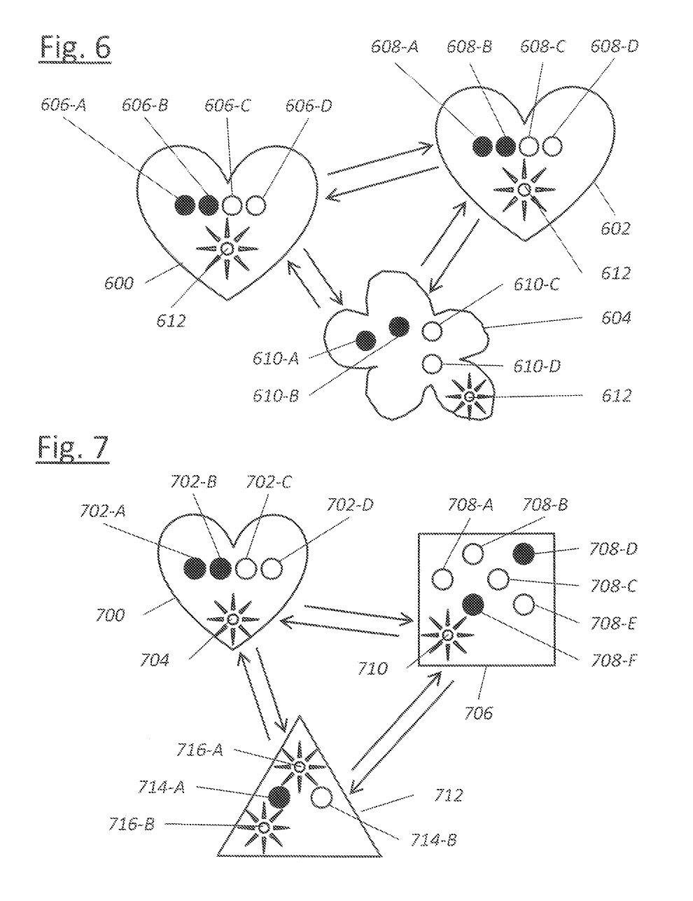

FIG. 6 illustrates how devices 600, 602, and 604 operated by a first, second, and third user, respectively, may be used to grant access to one another to data associated with each user and stored in the database 310. The data associated with a user may be, for example, data associated with a web page of the user on a social networking web site hosted on the web host 304. In this fashion, each of the first, second, and third users invites the other users to become a “friend” thereof.

Each of the devices 600, 602, and 604 is similar to the device 100 described herein above and includes at least one or more buttons, a transceiver, and color LEDs. In order to grant access, each user actuates predetermined combination(s) of one or more switches(s), e.g., by depressing such switches(s), on the device operated thereby. The device 600 includes switches 606 A-D, the device 602 includes switches 608 A-D, and the device 604 includes switches 610 A-D. The first user actuates switches 606-A and 606-B of device 600. In the duration when the switches 606-A and 606-B are actuated, the second user actuates switches 608-A and 608-B of the device 602 and the third user actuates switches 610-A and 610-B of the device 604. Actuating the switches in this fashion directs the processor 200 in each of the devices 600, 602, and 604 to operate the transceiver to transmit a signal that encodes the unique ID associated with such device. In addition, the processor 200 of each of the devices 600, 602, and 604 operates the transceiver of such device to receive one or more signal(s) transmitted by one or more of the other device(s), respectively. In some embodiments, the transceiver is operated in a low-power transmit mode and/or a low-sensitivity receive mode so that the range of the communications is between devices that are near one another. In some embodiments the transceiver is operated so that devices that are less than 5 centimeters, less than approximately 1 meter, or 5 meters apart may communicate therebetween. In other embodiments, the transceivers of devices may be operated so that only those devices within approximately 25 centimeters, within approximately 50 centimeters, or within approximately 1 meter of one another may communicate therebetween. In still other embodiments, devices within approximately 300 meters of one another may communicate therebetween. The devices do not have to touch one another or be positioned in particular orientations with respect to one another to exchange data therebetween.

In some embodiments, each device 600, 602, and 604 may be preconfigured with a unique delay. When the switches of such device are actuated, the processor waits the preconfigured delay to before directing the transceiver to transmit the unique ID. The delay may prevent the collision of the unique IDs transmitted from the multiple devices. In other embodiments, each user of the devices 600, 602, and 604 may actuate the switches of the device 600, 602, or 604 operated thereby sequentially to introduce a delay when the individual devices transmit the unique IDs. Introduction of such delay still allows the devices to exchange unique IDs substantially simultaneously. Some device may be configured to introduce a random delay.

Each received signal encodes the unique ID of the device that transmitted such signal. In this fashion, the device 600 transmits a signal encoding the unique ID associated therewith and receives a signal encoding the unique ID associated with the devices 602 and 604; the device 602 transmits a signal encoding the unique ID associated therewith and receives a signal encoding the unique ID associated with the devices 600 and 604; and the device 604 transmits a signal encoding the unique ID associated therewith and receives a signal encoding the unique ID associated with the devices 600 and 602. It should be apparent that any number of the devices might be used in the manner described above to exchange unique IDs among such devices.

Each of the devices 600, 602, and 604, stores the unique IDs received thereby in the memory thereof. In some embodiments, the signal transmitted by a device that encodes the unique ID associated with the device also encodes the identifying color selected by the user of the device (for example, at the block 406 described in FIG. 4). When a device 600, 602, or 604 receives such a signal and if the device includes LEDs 612, the processor 200 of the device 600, 602, or 604 directs the LED driver of the device 600, 602, or 604 to activate the LEDs 612 to display the identifying color previously stored or optionally encoded in the received signal. For example, suppose the device 600 includes red, green, and blue LEDs 612, and receives a signals transmitted by the device 602 that encodes the unique ID associated with the device 602 and the color purple is associated with the user of device 602 as the identifying color of such user. Upon receipt of such signal, the processor 200 of the device 600 directs the LED driver thereof to generate driver signal to cause the LEDs 612 to momentarily flash in such a combination to visually produce the color purple. In some embodiments, the identifying color is transmitted as a single value associated with a certain color. For example, values of 1, 2, 3, 4, 5, 6, may be transmitted to indicate colors red, green, blue, purple, aqua, and yellow. In other embodiments, the identifying color is transmitted as values of the red, green, and blue components thereof.

In some embodiments, the LED driver pulses the individual fixed output red, green, and blue LEDs 612 to simulate the received identifying color. In other embodiments, the LEDs 612 may be variable output LEDs and the LED driver varies the current and/or the voltage to such LEDs 612 to generate the received identifying color.

If a device includes a motor 206, the processor 200 of such device may actuate the motor 206 therein to produce a vibration of the device each time a unique ID is received thereby. Each device may be configured with different types of visual or tactile indicators as described above and such device may use the indicators provided therewith to indicate when a unique ID is received. Further, some devices may not produce any visual or tactile indications. It should be apparent that any type of sensory indicator may be incorporated into the devices described herein.

In some embodiments, the protocol used to communicate between devices may include a preamble that includes sync bytes that alert the receiving device that a message is forthcoming. The protocol may also error encoding and checksums that are added by the sending device and which may be used by the receiving device to insure that the message is received without errors.

The devices that participate in the exchange of unique IDs do not have to be identical. For example, devices 600 and 604 have difference shapes. FIG. 7 illustrates an example of devices that each have different shapes and different quantities of switches and LEDs. A device 700 has four switches 702A-D and a tri-color LED indicator 704. A device 706 includes six switches 708A-E and a monochromatic LED indicator 710. A device 712 includes two switches 714A and 714B and two monochromatic LED indicators 716A and 716B. Actuating the switches 702A and 702B of device 700, 708F and 708D of device 706, and 714A of device 712 causes the processor 200 of each device 700, 706, and 712 to direct the transceiver thereof to transmit a signal encoding the unique ID associated with such device to the other devices and to receive a signal encoding a unique ID from the other devices. Upon receiving such a signal from, for example, device 706, the device 700 may drive the LED indicator 704 to generate the identifying color associated with the unique ID. When the device 706 receives the signal from device 700 encoding a unique ID that is associated with a non-monochromatic color, however, the monochromatic LED of device 706 may just be pulsed because such LED cannot generate a variety of colors. In a similar fashion, the device 712 may pulse various combinations of LEDs 716A and 716B in response to receiving such signals from the devices 700 and 706.

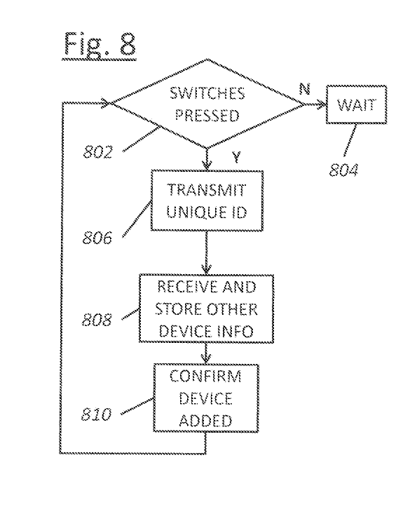

FIG. 8 is a flowchart of the steps undertaken by a processor 200 of an embodiment of a device to exchange unique IDs with other devices. A block 802 determines if a preconfigured combination of switches of the devices is actuated and if such combination is not actuated the processor 200 proceeds to a block 804 to wait, otherwise, the processor 200 proceeds to a block 806. In some embodiments, the block 804 may idle the processor 200 until an interrupt is received indicating that one or more switches have been actuated. In other embodiments the block 804 may wait for a predetermined amount of time to pass before returning to the block 802. In still other embodiments, block 804 may operate the processor 200 and/or other components in a low-power mode to conserver power.

At the block 806, the processor 200 directs the transceiver of the device to generate a sync signal that encodes the unique ID and in some embodiments the identifying color stored at the blocks 502 and 506 as described above, respectively. A block 808 waits for receipt of a sync signal from any other devices encoding the unique ID and in some embodiments identifying colors associated therewith. Upon receipt of such a signal, the block 808 stores the received unique ID and the received identifying color (if any) into the memory of the device. A block 810 generates the visual, tactile, and/or other sensory indication that the unique ID of another device has been successfully received and stored in the memory of the device.

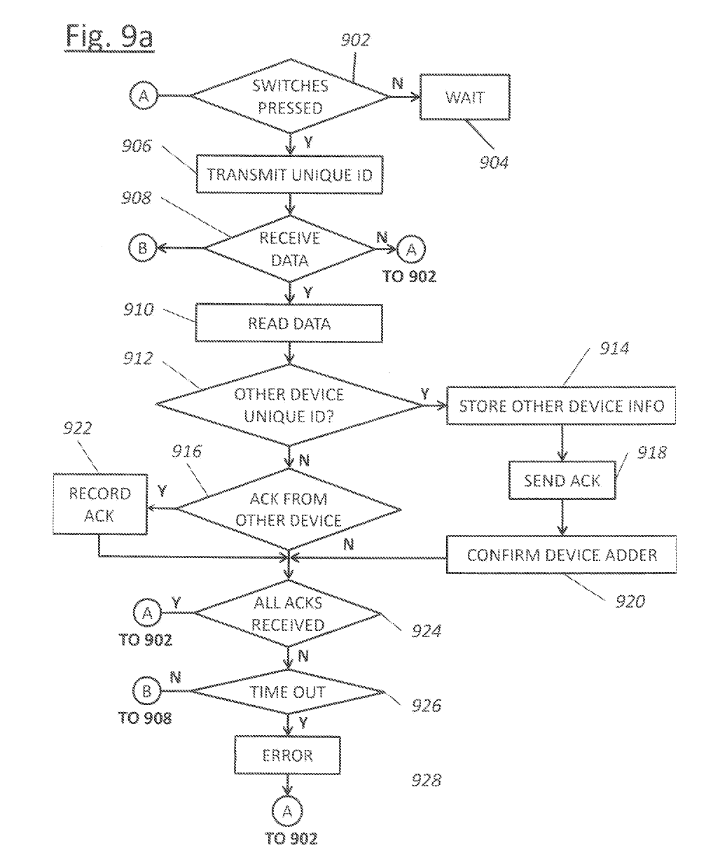

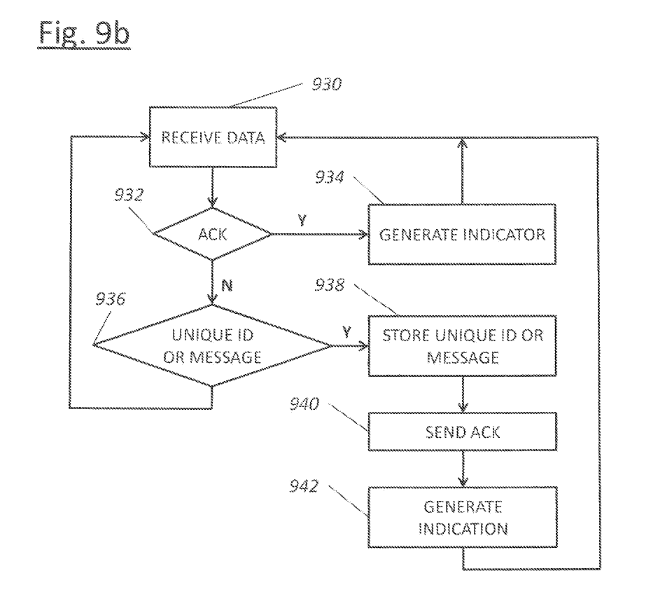

FIG. 9A illustrates another flowchart of code that may be executed by the processor 200 of a device to exchange information with other devices. A block 902 determines if a preconfigured combination of switches is actuated on the device. If such combination is not activated then the execution proceeds to a block 904 that waits as described above with respect to the block 804. Otherwise, execution proceeds from the block 902 to a block 906 that directs the transceiver to generate a signal to transmit the unique ID associated with the device. A block 908 determines if any data has been received by the transceiver of the device. If data has been received, then execution proceeds to a block 910 that reads such data, otherwise, execution return to the block 902. A block 912 determines if the data read is associated with the transmission of a unique ID by one of the other devices and, if so, execution proceeds to a block 914, otherwise execution proceeds to a block 916.

The block 914 stores the unique ID and the identifying color received, a block 918 directs the transceiver to generate a signal that encodes an acknowledgement of the received unique ID and the identifying color, and a block 920 generates the visual, tactile, and/or other signals to the user to indicate that the unique ID has been recorded. Execution proceeds from the block 920 to a block 924.

The block 916 determines if the data read at the block 910 is an acknowledgment of the transmitted unique ID from another device and, if so, execution proceeds to a block 922, otherwise, execution proceeds to a block 924. The block 922 records the unique ID of the device that transmitted the acknowledgement and execution proceeds to the block 924.

The block 924 determines if an acknowledgement has been received from each device from which unique IDs have been received and if so execution returns to the block 902. Otherwise, a block 926 determines if a predetermined amount of time has elapsed since receiving an acknowledgment from any other device and, if so, proceeds to a block 928. Otherwise execution returns to the block 908. The block 928 generates a visual, tactile, or other sensory signal indicating to the user of the device that an error in exchanging unique IDs may have occurred and returns to a block 902. Upon noting the indication of the error, the user may wish to restart the exchange process.

FIG. 9B illustrates a flowchart of the execution undertaken by an embodiment of a processor 200 of a device to receive data from another device. A block 930 waits for data to be received. The block 930 may periodically poll the receive buffer associated with the transceiver or be activated by an interrupt in response to receipt of data by the transceiver. A block 932 determines if the received data is an acknowledgement of a previously sent message or unique ID (for example, one sent by either of the blocks 806 or 906). If the received data is an acknowledgement, the block 934 generates a visual, tactile, or other or other sensory output that a message or unique ID transmission has been acknowledged and returns to the block 930.

If the block 932 determines that the received data is not an acknowledgment, then execution proceeds therefrom to a block 936 that determines whether the received data is a unique ID or message transmitted by another device and if so execution proceeds to a block 938, otherwise execution proceeds to the block 930. The block 938 stores the received unique ID or message. The block 940 directs the transceiver to transmit an acknowledgement message in response to the received data and the block 942 generates a visual, tactile or other indication that a unique ID or message has been received.

Referring once again to FIG. 3, when the device 100 is connected to the personal computer 300, the communications software operating on the personal computer 300 retrieves any unique IDs and identification colors received from other devices and stored on the device 100. The communications software sends such unique IDs and identification colors to the authentication server 308 of the web host 304. The authentication server 308 records the users of the devices associated with such unique IDs as being friends of the user of the device 100. In some embodiments, the authentication server 308 may add the user of the device 100 as a friend of each of the users of the devices associated with such unique IDs.

In some embodiments, if a first user and a second user have exchanged unique IDs, the authorization server 308 grants friends access to the first user and the second user only after the unique ID of the first user is uploaded from the device of the second user and the unique ID of the second user is uploaded from the device of the first user. If the unique ID of the first user is uploaded before the unique ID of the second user, the authorization server 308 may mark the friend status in the database 310 between the first user and second user as pending until the unique ID of the second user is uploaded.

In addition, a web page may be generated by the web server 306 that is displayed in a web browser operated by the user of the device 100. Such web page may show each unique ID and identification color retrieved from the device 100 and may allow the user to associate an identification color with name and such unique ID. Further, the web page may allow the user to assign a different color to friend associated with the unique ID.

The authentication server may mark the addition of friends in the database as pending until approval has been received from the parent or guardian of the user of the device 100. In some embodiments, the parent or guardian may need to enter a parent-id and password to provide such approval. In other embodiments, the authentication server may generate an e-mail message to which the parent or guardian must respond to provide approval.

In some embodiments, the exchange of unique IDs may be undertaken between a device and other devices as described above in connection with FIGS. 6-9 before such device has been registered as described in above in connection with FIGS. 3-5. In such embodiments, any unique IDs stored in such device may be sent to the authentication server after registration has been completed, for example, after the execution of the block 412 of FIG. 4 and the block 508 of FIG. 5.

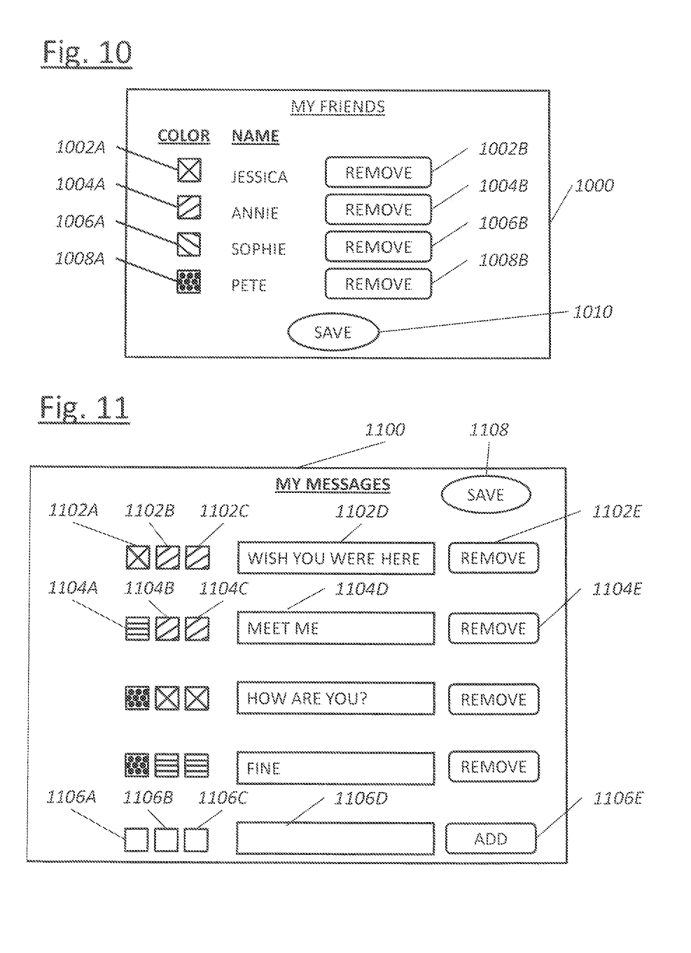

FIG. 10 shows a web page 1000 associated with a user that may be used by the user to associate colors and names with friends, wherein each friend is associated with a device and the unique IDs of the device associated with the user and the device associated with friend have been exchanged as described above. The web page 1000 shows that colors 1002A, 1004A, 1006A, and 1008A are associated friends named “Jessica,” “Annie,” “Sophie,” and “Pete,” respectively. In some embodiments, the user may associate one color with a plurality of friends.

In addition, the web page includes buttons 1002B, 1004B, 1006B, and 1008B associated with the friends named “Jessica,” “Annie,” “Sophie,” and “Pete,” respectively. The user may select one of these buttons to remove the friend associated therewith from the friends list of the user. In particular, selecting one of the buttons 1002B, 1004B, 1006B, or 1008B causes the web server 306 to direct the authorization server 308 to modify the entry associated with the user in the database 100 and remove the unique ID of the device used by the friend associated with the selected button. In some embodiments, if a user removes another user as a friend, the authorization server 308 prevents any further communications therebetween until the other user is reinstated as a friend.

The web page 1000 also includes a button 1010 and selecting such button causes the web site to direct the communications server to store the unique IDs of only those devices that are operated by friends of the user as recorded in the database.

In some embodiments, a device operated by a user transmits a unique ID to another device. The receiving device selects the color that is associated with the transmitting device. In some embodiments, the LEDs 106 of the receiving device are actuated to generate the selected color. In some embodiments, the color is selected from a palette of predetermined colors and that have not been assigned to other devices. When the receiving device is connected to the personal computer 300, such color information and unique ID of the transmitting device are sent to the authentication server 308 and recorded in the database 310. Such color is displayed in the color boxes associated with the user of the other device on the web page 1010.

FIG. 11 illustrates a web page 1100 that the user may use to define message codes. In particular, a message is associated with a color sequence. For example, the sequence of colors shown in boxes 1102A-C is associated with the message string shown in the box 1102D. Selecting one of the boxes 1102A-C allows the user to select another color for such box and thus change the color sequence associated with the message string in the box 1102D. In some embodiments, the user type directly into the box 1102D to associate a new message string with the color sequence that is displayed in boxes 1102A-C. Similarly, the color sequence displayed by boxes 1104A-C is associated with the message string shown in box 1104D.

If the user selects the button 1102E, then the boxes 1102A-D are removed from the web page 1100. The user may use empty (or undefined) boxes 1106A-C and an empty message box 1106D to associate additional color sequences with message strings. In particular, the user may associate a color with each of the boxes 1106A-C as described above, enter a message string into the box 1106D, and select the button 1106E.

After the user has associated color sequences with messages as described above, the user may select the button 1108. Doing so, causes the web server 300 to save the color sequences and associated messages into an entry associated with the user in the database 310. Further the web server 300 directs the communications software operating on the computer 300 to send the color sequences stored in the database to the device using the USB interface thereof. In this manner the color sequences are stored on the device.

The color sequences defined by the user in the web page illustrated in FIG. 11 may be provided with other users who are friends of the user. In this manner, when one such friend receives a message from the user on a device operated by the friend and device operated by the friend generates the color sequence defined by the user, the friend will be able to decipher the color sequences.

In some embodiments, the device may be preconfigured with color sequences associated with certain messages. Such messages may be transmitted by the user of the device to other devices without having to configure messages using the web page illustrated in FIG. 11. Further, the user may use the device to transmit such preconfigured messages before the device is initialized using the personal computer 300 as described above.

In other embodiments, the boxes 1102A-C and/or 1104A-C may be associated with other sensory output such as a vibration or sound. For example, the box 1102A may be associated with a vibration of a device, the box 1102B may be associated with a sound of a bird, and the box 1102C may be associated with a certain color. Such combinations of sensory output may be used for generating a message on devices as described herein.

The user may use the device operated thereby to send messages to devices operated by other users who may be in the communications range of the transceivers in such devices. In one embodiment, the user actuates a predetermined combination of the switches on the device operated thereby to initiate the sending of a message. In some embodiments, a particular switch is actuated a predetermined number of times with a certain time period. In other embodiments, a particular combination of switches is actuated in a certain sequence. In one embodiment, the device displays a particular color or sequence of colors on the LEDs of the device, vibrates the device, and/or provides other sensory feedback to confirm that message sent message has been received. Thereafter, the user may actuate a particular switch on the device to select the recipient. In particular, each time the particular switch is actuated, one of the colors associated with the user in the web page 1000 is displayed by the LEDs of the device. In one embodiment, the colors are displayed in the order in which the user has defined them in the web page 1000.

When the color of the recipient is displayed, the user actuates another predetermined switch to select a message that is to be sent. Each time the user actuates such switch, a color sequence associated with one of the message strings in the web page 1100 is displayed by the LEDs of the device. For example, if the user wishes to send the message string in the box 1102D, the user actuates the switch until the LEDs flash, in order, a sequence of colors identical to those shown in boxes 1102A-C. In some embodiments, actuation of the switch to select a message cycles through the messages in order in which such messages appear on the web page 1100.

After selecting the recipient and the message, the user actuates a predetermined switch or combination of switches to transmit the message to the device operated by the recipient. The data transmitted includes the unique ID of the device operated by the recipient. In some embodiments, transmitted messages may be encrypted using symmetric and asymmetric encryption techniques to insure that only the device of an intended recipient may be able to decode the message. The encryption/decryption keys for such encryption/decryption may be generated from the unique IDs associated with each device.

As described in connection with FIG. 9B, a device 100 operated by the recipient detects a message intended therefor, the color code associated with the message is extracted. The processor 200 of the device 100 operated by the recipient directs the LED drivers to generate the color sequence (or other sensory output) associated with the message using the LEDs on the device operated by the recipient (for example by the block 942 of FIG. 9B).

In some embodiments, the processor 200 of the device operated by the recipient actuates in the motor in such device to cause the device to vibrate when the message is received. The processor 200 of the device sending the message may also cause the sending device to vibrate by actuating the motor thereof. It should be apparent any type(s) of sensory output (e.g., auditory, tactile, visual, olfactory, or a combination thereof) available in the device could be used to indicate that a message has been received thereby.

Each user who has a device is provided with web pages where such user may enter notes, activities, interests, and the like. The user may be allowed to develop their own web pages or blogs or to upload photos and movies. Such content is stored on the web server 306 in a space associated with the user or in the database 310 in entries associated with the user. In some instances the database 310 has entries associated with the user that include references to data stored on the web server. The web server uses the content entered by the user to generate web pages that are presented to a web browser executing on a personal computer. However, such web pages are only presented to another user if a unique ID identical to the unique ID associated with the device operated by the user has been previously retrieved from the device operated by the other user.

If the communications software is also operating on the personal computer used thereby, the communications software has retrieved a unique ID from a device plugged into the personal computer, and the unique ID is identical to the unique ID associated with the device operated by the user who created the content or with a device operated by a friend of the user.

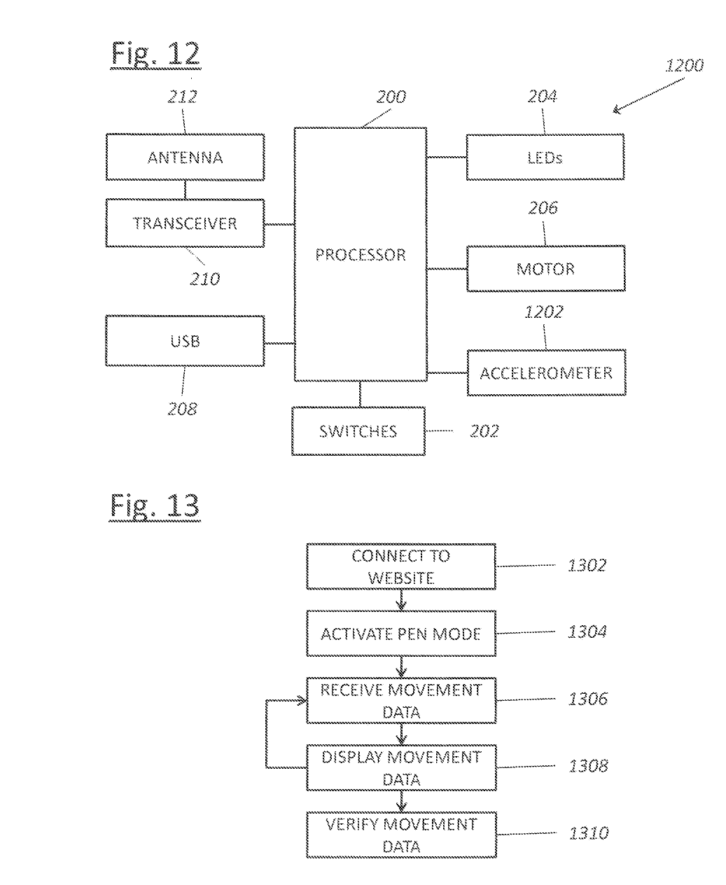

FIG. 12 illustrates a block diagram of an embodiment of a device 1200. The device 1200 is identical to the device 100 except the device 1200 incorporates an accelerometer 1202. The device 1200 may be operated to perform all of the functions of the devices described hereinabove. In addition, the device 1200 may be operated to provide access to a web page or other software by moving such device along a predetermined path. In particular, a user may create a motion-password by moving the device 1200 along a particular path and requesting that the communications software record information about such path in the authorization server 308.

FIG. 13 comprises a flowchart that shows the execution of the communications software on the personal computer 300 that may be used to obtain the motion-password from the device 1200 to allow the user thereof access to a page on the web server 306. A block 1302 connects to the web server 306 and detects the needs for the motion-password. A block 1304 connects to the device 1200 and sends an instruction to the processor 100 thereof to activate pen mode. A block 1306 receives movement data sensed by the accelerometer 1202 of the device 1200. In some embodiments, the accelerometer 1202 senses data while a particular switch 202 is actuated on the device 1200. In another embodiment, the accelerometer 1202 continues to sense motion until a particular switch 202 is actuated.

A block 1308 may display on a display of the personal computer 300 a drawing of the motion-password entered. In some embodiments the blocks 1306 and 1308 iterate until the user indicates that the motion-password entry is complete. It should be apparent, that the block 1308 is optional.

A block 1310 transmits the data received by the block 1306 to the authorizations server 308 for verification. If the authorization server 308 determines that the transmitted data sufficiently matches the motion-password previously stored in the database, the authorization server 308 allows the user to access the web page hosted on the web server 306.

In some embodiments, the authorization server 308 scales or normalizes the data received thereby from the blocks 1310 before comparing such data with the previously stored data.

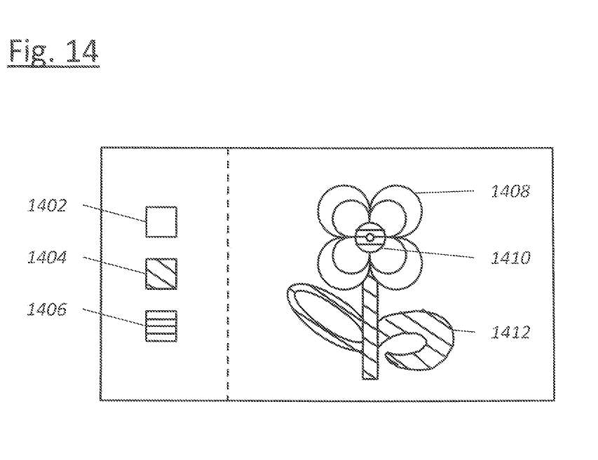

The motion-password data may include color data. For example, a portions of a path traced by the user may be associated with a first color and another portion of the path traced by the user may be associated with a second color. FIG. 14 shows an example of how a user may enter such a path. FIG. 14 may be a display generated by the communications software when the blocks 1304 through 1308 are executed. The display includes color boxes 1402, 1404, and 1406, associated with first, second, and third colors, respectively. Prior to drawing a first portion 1408 of a path, the user selects the color associated with the box 1402. Upon completion of the first portion 1408, the user selects the color associated with the box 1404 and traces a portion 1410 of the path. Thereafter, the user selects the color associated with the box 1406 and traces a portion 1412 of the path. The user may use the device to position a cursor on the screen to select a color or may user another pointing device such as a mouse or touch-screen to control such cursor. Once the user indicates that the entire path has been entered, the box 1310 transmits the coordinates associated with the portions 1408, 1410, and 1412 and the colors associated with such portions to the authorization server 308. The authorization server 308 determines if the color and position transmitted substantially match the previously entered color and position data and, if so, allows the user to access the web server 306.

It should be apparent that the position data collected by the accelerometer 1202 may be either 3-dimensional or 2-dimensional point data. It should also be apparent that the position data may be mixed with switch actuations at certain points along the path and such switch actuations may be sent to the authorization server 308.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method for allowing first and second participants access to data stored on a server, wherein the data is associated with a user, the method comprises the steps of:
associating first and second authentication devices with the first and second participants, respectively;
associating an authentication device with the user;
substantially simultaneously transmitting authentication information from the authentication device associated with the user to the first and second devices; and
transmitting the authentication information from the first device and the second to an authentication server, whereby the authentication server provides the first participant and the second participant, respectively, access to the data.

2. The method of claim 1, wherein the authentication information comprises a unique ID associated with the device;

3. The method of claim 1, wherein the method comprises the step of associating unique authentication information with the each of the devices operated by the user, the first participant, and the second participant.

4. The method of claim 3, wherein the step of transmitting comprises the step of transmitting unique authentication information associated with the device operated by the user.

5. The method of claim 4, wherein method comprises the further step of transmitting unique authentication information associated with the device operated by the first participant.

6. The method of claim 5, wherein the authorization service provides the first participant access to the data after unique authentication information associated with devices operated by the user and the first participant have been transmitted.

7. The method of claim 1, wherein the method comprises the step of receiving by the device associated with the user authentication information transmitted by the device associated with the first participant.

8. The method of claim 7, wherein the method comprises the step of providing an indication at the device associated with the user that authentication information has been received.

9. The method of claim 8, wherein the indication comprises generation of an indicator that is visual, audible, tactile, or a combination thereof.

10. The method of claim 1, wherein the method comprises the step of transmitting a message from the device associated with the user to the device associated with the first participant.

11. The method of claim 10, wherein the step of transmitting a message from the device associated with the first user comprises the step of selecting a message to transmit.

12. The method of claim 11, wherein the step of selecting a message comprises the step of actuating a switch on the device associated with the user.

13. The method of claim 10, wherein the method comprises the step of associating a combination of sensory output with the message.

14. The method of claim 13, wherein the step of transmitting the message comprises the step of causing the sensory output component of the device associated with the first participant to generate the combination of colors associated with the message.

15. A device associated with a user for allowing first and second participants access to data stored on a server and associated with the user, wherein the device comprises:
a memory for storing authentication information;
a wireless transceiver that substantially simultaneously receives first and second authentication information from devices operated by the first and second participants, respectively, and stores such authentication information into the memory; and
an interface that transfers the authentication information stored in the memory to a server, whereby the server provides the first and second participants access to the data.

16. The device of claim 15, wherein the device comprises a processor that directs the transceiver to transmits authentication information associated with the device.

17. The device of claim 16, wherein the devices comprises a switch and actuation of the switch causes the processor to direct the transceiver to transmit the authentication information.

18. The device of claim 16, wherein actuation of the switch further causes the processor to direct the transceiver to receive authentication information from another device.

19. The device of claim 17, wherein the device comprises a visual output component, a tactile output component, a sound generator, or a combination thereof and, in response to receipt of authentication information from another device, the processor actuates the visual output component, the tactile output component, or the sound generator.

20. The device of claim 15, wherein the transceiver transmits a message from the device associated with the user to a device associated with the first participant.

21. The device of claim 20, wherein device comprises a switch and the user actuates a switch to select the message to be transmitted.

22. The device of claim 15, wherein the transceiver receives a message from the device associated with the first participant.

23. The device of claim 22, wherein the device comprises a visual output and a processor and in response to receiving the message, processor directs the visual output to generate the combination of colors associated with the message.

24. The device of claim 23, wherein the device comprises a motor and the processor actuates the motor in response to receiving the message.
